(19) United States
(12) Patent Application Publication
(10) Pub. No.: US 2007/0262244 A1
(43) Pub. Date: Nov. 15, 2007

(54) Fingerprinting Device

(75) Inventors: Franz Padinger, St. Marien (AT); Klaus G. Schroter, Berlin (DE)

Correspondence Address: ROBERT R. PRIDDY;LAW OFFICE OF ROBERT PRIDDY, 13511 QUERY MILL ROAD, N. POTOMAC, MD, 20878, US

(73) Assignee: NANOIDENT TECHNOLOGIES AG, Linz (AT)

(21) Appl. No.: 11/662,318

(22) PCT Filed: Aug. 24, 2005
(86) PCT No.: PCT/AT05/00337

§ 371 Date: Mar. 26, 2007

(30) Foreign Application Priority Data
Sep. 8, 2004 (AT) A 1501/2004

(51) Int. Cl. G01J 1/44

(52) U.S. Cl. 250/214 R

(57) ABSTRACT

Described is a fingerprinting device (1) with a translucent top layer (7) which forms a finger rest and on the side of which that is remote from the finger rest a layer, connected to an evaluation circuit (10), of light-sensitive elements (9) in a matrix arrangement and light-emitting elements (8) are provided. In order to provide advantageous design conditions, it is proposed that on the side of the top layer (7) that is remote from the finger rest there be arranged a photoactive layer (2) based on organic semiconductors between two electrode layers (3, 4) consisting of intersecting strip conductors (5, 6), of which the strip conductors (5) between the photoactive layer (2) and the top layer (7) are translucent, and that the photoactive layer (2) form the light-sensitive and the light-emitting elements (8, 9) in the region of intersection of the strip conductors (5, 6) of the two electrode layers (3, 4).

### FIELD OF THE INVENTION

The invention relates to a fingerprinting device with a translucent top layer which forms a finger rest and on the side of which that is remote from the finger rest a layer, connected to an evaluation circuit, of light-sensitive elements in a matrix arrangement and light-emitting elements are provided.

### DESCRIPTION OF THE PRIOR ART

In order to be able digitally to record a fingerprint, without firstly optically imaging the fingerprint using a lens system, it is known (WO 97/036544 A1) to arrange light-sensitive elements, preferably photodiodes or phototransistors, using thin-layer technology on a transparent carrier made of glass or quartz and to cover them with a light-emitting layer consisting, for example, of electroluminescent diodes. As the light-sensitive elements are arranged in rows in a matrix and the rows of elements are separated from one another by translucent gaps, light can be cast from the light-emitting layer, through the translucent gaps and the transparent carrier, onto the finger which is positioned, for recording a fingerprint, against the carrier acting as a finger rest. The light, which is reflected differently at the ridges and recesses of the skin, is detected by the light-sensitive elements, the electrical signals of which, which are dependent on the intensity of the reflected light, are transmitted in an elementary manner into an evaluation circuit for producing a digital image of a fingerprint. The main drawback of this known fingerprinting device is the design costs caused by the use of light-sensitive elements based on inorganic semiconductors; in addition, the fingerprint to be recorded can be illuminated merely by comparatively narrow gaps between the light-sensitive elements.

### SUMMARY OF THE INVENTION

The object of the invention is accordingly to construct a fingerprinting device of the type described at the outset in such a way as to allow a digital image of a fingerprint to be obtained using simple constructional means.

The invention achieves the object set in that on the side of the top layer that is remote from the finger rest there is arranged a photoactive layer based on organic semiconductors between two electrode layers consisting of intersecting strip conductors, of which the strip conductors between the photoactive layer and the top layer are translucent, and in that the photoactive layer forms the light-sensitive and the light-emitting elements in the region of intersection of the strip conductors of the two electrode layers.

The use of a photoactive layer based on organic semiconductors results in comparatively simple design conditions based firstly on the solubility of the organic semiconductor materials in conventional solvents and secondly on the low movability, compared to inorganic semiconductors, of the charge carriers, so no particular measures are required to delimit individual light-sensitive regions from one another. These light-sensitive regions are determined by the intersecting strip conductors of the electrode layers adjoining the photoactive layer on either side, because the conveyance of charge is substantially restricted to the region of intersection of the strip conductors and the influence of a charge movement between adjacent regions of intersection of the strip conductors within the photoactive layer can generally be disregarded. In addition, the application of an excitation voltage causes correspondingly constructed photoactive layers of this type also to emit light, thus obviating the need for a separate light-emitting layer. After all, an electrical voltage can be applied to selected regions of the photoactive layer via the associated strip conductors of the two electrode layers for the emission of light. In order to be able to use this light for the illumination and recording of the fingerprint, the electrode layer is to be translucent between the photoactive layer and the top layer.

The demands, on the one hand, for high light sensitivity and, on the other hand, for an effective light yield with low excitation energy necessitate generally differing measures with regard to the construction of the photoactive layer. For this reason, the photoactive layer can have, in the region of the light-emitting elements, a construction differing from the regions of the light-sensitive elements. On account of the solubility of organic semiconductors in conventional solvents, this differing construction does not entail any difficulties, especially as the solutions can be applied point by point adjacently to one another. This means, for example, that two molecular components can be used for the light-sensitive regions of the photoactive layer, namely a conjugated polymer component as the electron donor and a fullerene component as the electron acceptor, whereas merely a conjugated polymer is used for the light-emitting elements. As a result of the absence of an electron acceptor, there can be emitted, on application of an electrical voltage to these polymer regions, light which is used for illuminating the fingerprint to be recorded and can be detected and evaluated after diffuse reflection of the light-sensitive regions of the photoactive layer.

As a result of the definition of specific light-emitting regions of the photoactive layer, it is expedient to read out the output signals from the light-sensitive elements into the evaluation circuit as a function of the local position of the respectively activated light-emitting elements, so the entire fingerprint consisting of subsequently illuminated portions is recorded region by region and is composed of the recorded individual regions, and this restricts the excitation energy to be provided for the light-emitting elements which, after all, can be activated one after another in any desired sequence.

The output signals from the light-sensitive elements can be read out not only as a function with respect to location of the light-emitting elements but also as a function with respect to time of the activation of the light-emitting elements. This measure can ensure that the light reflected on the fingerprint is evaluated and the emitted light does not influence the evaluation prior to the reflection thereof on the fingerprint. After all, dependency with respect to time of this type rules out charge movements between light-emitting and light-sensitive elements.

### BRIEF DESCRIPTION OF THE DRAWINGS

The drawings show the subject-matter of the invention by way of example. In the drawings:

FIG. 1 is a schematic cross section of a fingerprinting device,

FIG. 2 is a schematic, partially exploded plan view of the device shown in FIG. 1, and

FIG. 3 is a block diagram for the activation and evaluation of a fingerprinting device according to the invention.

### DESCRIPTION OF THE PREFERRED EMBODIMENT

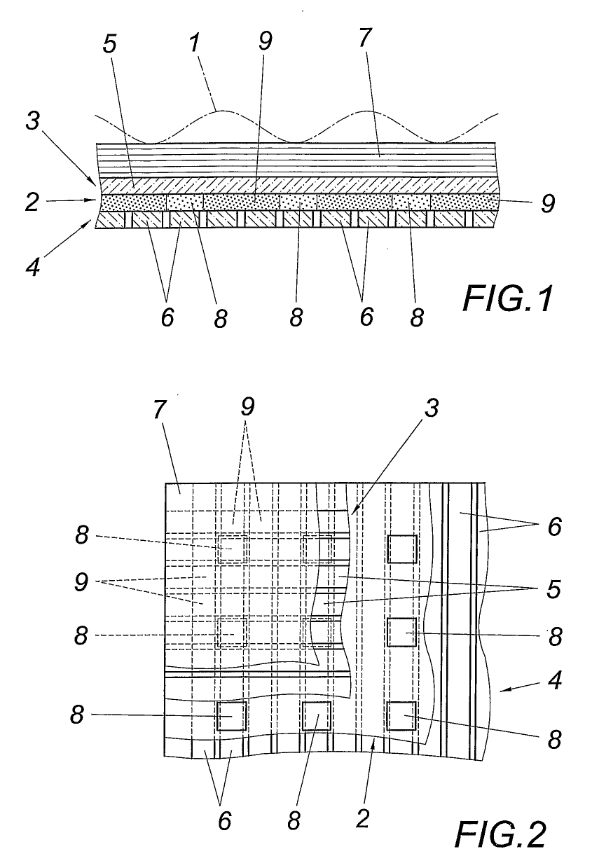

As may be seen, in particular, in FIG. 1 and 2, the illustrated device for recording a fingerprint 1 indicated in FIG. 1 by a broken line has a photoactive layer 2 adjoined by two electrode layers 3, 4 consisting of intersecting strip conductors 5, 6. The photoactive layer 2 is constructed on the basis of organic semiconductors, the charge movability of which parallel to the layer face is comparatively small, thus producing photoactive elements substantially separated from one another in the region of intersection of the strip conductors 5, 6. In order to be able, on the one hand, to illuminate the fingerprint 1 through a translucent top layer 7 forming a finger rest and, on the other hand, to detect the light reflected diffusely on the fingerprint 1 for imaging the fingerprint, individual regions of the photoactive layer 2 that are locally defined by the region of intersection of specific strip conductors 5, 6 are used as light-emitting elements 8 and the remaining regions are used as light-sensitive elements 9. Although it is in principle possible to choose a construction of the photoactive layer 2 in such a way that the individual elements in the region of intersection of the strip conductors 5, 6 can act, as a function of the activation, either as light-emitting elements 8 or as light-sensitive elements 9, a differing construction of the photoactive layer 2 for the light-emitting and the light-sensitive elements 8, 9 allows the light yield and the light sensitivity to be increased. For this purpose, the photoactive layer 2 in the local region of the light-emitting elements 8 preferably consists merely of a conjugated polymer, whereas the photoactive layer in the remaining region is composed of two molecular organic components, namely a conjugated polymer component as the electron donor and a fullerene component as the electron acceptor. FIG. 1 and 2 indicate these differing regions of the active layer 2.

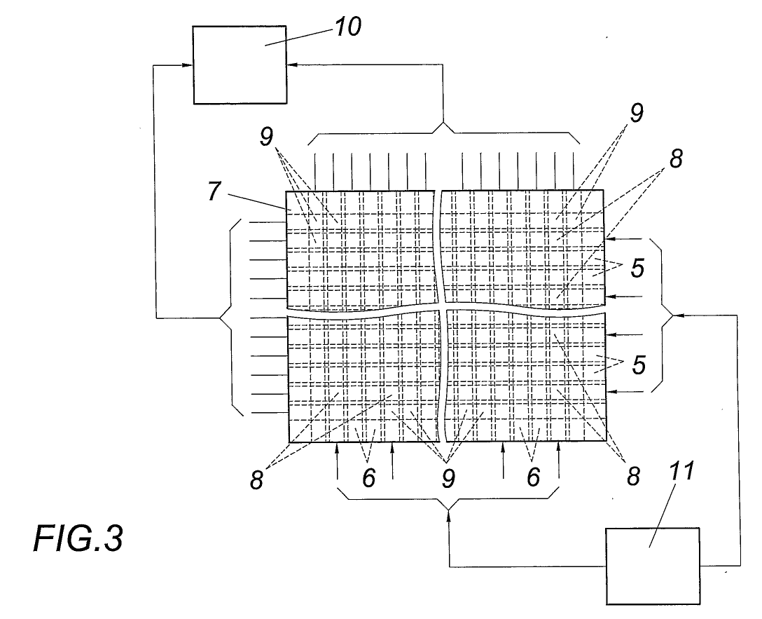

In addition to the differing construction of the light-emitting elements 8 and the light-sensitive elements 9, these elements also have to be activated differently. Whereas the light-sensitive elements 9 as shown in FIG. 3 are connected to an evaluation circuit 10 via the strip conductors 5, 6, the light-emitting elements 8 are activated via a control means 11 which is connected to the strip conductors 5, 6 intersecting in the region of the light-emitting elements 8. On account of the passage of light, necessary for illuminating the fingerprint and detecting the reflected light, through the electrode layer 3, the strip conductors 5 of this electrode layer 3 are to be translucent.

In order to record the ridges in the skin, separated from one another by groove-like recesses, of a fingerprint 1, the light-emitting elements 8 of the photoactive layer 2 are preferably successively activated in a time sequence in order to detect via light-sensitive elements 9 the light reflected diffusely on the fingerprint 1 of the finger resting against the top layer 7. These light-sensitive elements 9 are selected as a function of the local position of the light-emitting elements 8 within the matrix of elements in order to read out into the evaluation circuit 10 the output signals, which are dependent on the intensity of the reflected light, from the light-sensitive elements 9 via the associated strip conductors 5, 6. The fingerprint is thus recorded region by region and the respectively individually recorded regions are combined to form the complete image of the fingerprint. In order to avoid interference between adjacent elements 8, 9 of the photoactive layer, the output signals from the light-sensitive elements 9 can be read out into the evaluation circuit as a function with respect to time of the activation of the light-emitting elements 8, so merely the reflected light is detected via the light-sensitive elements 9.

1. Fingerprinting device with a translucent top layer which forms a finger rest and on the side of which that is remote from the finger rest a layer, connected to an evaluation circuit, of light-sensitive elements in a matrix arrangement and light-emitting elements are provided, wherein on the side of the top layer (7) that is remote from the finger rest there is arranged a photo-active layer (2) based on organic semiconductors between two electrode layers (3, 4) consisting of intersecting strip conductors (5, 6), of which the strip conductors (5) between the photoactive layer (2) and the top layer (7) are translucent, and in that the photoactive layer (2) forms the light-sensitive and the light-emitting elements (8, 9) in the region of intersection of the strip conductors (5, 6) of the two electrode layers (3, 4).

2. Device according to claim 1, wherein the photoactive layer (2) has, in the region of the light-emitting elements (8), a construction differing from the regions of the light-sensitive elements (9).

3. Device according to claim 1, wherein the output signals from the light-sensitive elements (9) can be read out into the evaluation circuit (10) as a function of the local position of the respectively activated light-emitting elements (8).

4. Device according to claim 1, wherein the output signals from the light-sensitive elements (9) can be read out into the evaluation circuit (10) as a function with respect to time of the activation of the light-emitting elements (8).
